(19) United States
(12) Patent Application Publication
(10) Pub. No.: US 2008/0293412 A1
(43) Pub. Date: Nov. 27, 2008

(54) Location update with multipoint functionality

(75) Inventors: Tom Grahn, Vantaa (FI); Miikka Huomo, Espoo (FI); Mika P. Hietala, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/802,913

(22) Filed: May 25, 2007

(51) Int. Cl. H04Q 7/20

(52) U.S. Cl. 455/435.1

(57) ABSTRACT

The present invention provides methods for performing a location update in a mobile communication network. According to an embodiment of the invention, after receiving a location update request message from a managing node, a data base composes a location update acknowledge message including information about an identification of a switching device. Then the data base transmits the location update acknowledge message including information about the identification of the switching device to the managing node. According to another embodiment, after receiving a message from a second managing node, a first managing node composes a reply message including information about an identification of a switching device. Then the first managing node transmits the reply message including information about the identification of the switching device to the second managing node. Further, the present invention also relates to respective devices.

### FIELD OF THE INVENTION

The present invention relates to location update procedures in a mobile communication system.

### BACKGROUND OF THE INVENTION

During a location update in a mobile communication system, like e.g. GPRS (General Packet Radio Service), when a mobile station MS moves to a new SGSN (Serving GPRS Support Node), the new SGSN has to make a location update to a MSC/VLR (Mobile Switching Center/Visitor Location Register) after the new SGSN has first made a location update to a HLR (Home Location Register). This means that the new SGSN has to send Location Update Request message to MSC/VLR in order to update the SGSN number to VLR database. When multipoint functionality is used in combination with a Gs-interface between an SGSN and an MSC/VLR, there may exist a situation in which the MSC/VLR that should be contacted is not known. In this case, the SGSN utilizes the RAI (Routing Area Identity) and a hash value from the IMSI (International Mobile Subscriber Identity) in order to determine the number of the MSC/VLR.

However, this procedure has a number of drawbacks, because it is not explicitly specified how the MSC/VLR number is derived from the IMSI and therefore this method is not always reliable. That is, there may be a different implementation in different SGSNs. Thus, there might occur a problem that there are different hash results in different SGSNs or that there are different numbers of VLRs in a pool area, which offer different results of hash codes. Thus, the location update to the MSC/VLR might be incorrect.

### SUMMARY

The present invention provides methods and respective devices for sending the MSC/VLR number directly instead of having the SGSN derive it from the RAI and IMSI.

The methods according to the present invention allow the SGSN to be certain of sending the location update to the correct MSC/VLR. Thus, the present invention provides a faster combined location update when multipoint functionality is used. With the method according to the present invention, since the correct MSC/VLR is contacted, the attach procedure will be faster and the end user will get a better feeling of service.

According to an aspect of the present invention, there is provided a method comprising: receiving, at a data base, a location update request message from a managing node, composing, at the data base, a location update acknowledge message including information about an identification of a switching device, and transmitting, by the data base, the location update acknowledge message including the information about the identification of the switching device to the managing node.

According to further refinements of the invention as defined under the above aspect,

the managing node is a serving GPRS support node, the data base is a home location register and the switching device is a mobile switching center in a GPRS mobile communication network; and

the identification of the switching device is the number of a MSC/VLR.

According to a further aspect of the present invention, there is provided a method comprising: receiving, at a managing node, a message from another managing node, composing, at the managing node, a reply message including information about an identification of a switching device, and transmitting, by the managing node, the reply message including the information about the identification of the switching device to the other managing node.

According to further refinements of the invention as defined under the above aspect,

the managing node is an old serving GPRS support node, the other managing node is a new serving GPRS support node, the data base being a home location register and the switching device is a mobile switching center in a GPRS mobile communication network; and

the identification of the switching device is the number of a MSC/VLR.

According to a further aspect of the present invention, there is provided a data base, comprising: a receiver adapted to receive a location update request message from a managing node, a message composing unit adapted to compose a location update acknowledge message including information about an identification of a switching device, and a transmitter adapted to transmit the location update acknowledge message including the information about the identification of the switching device to the managing node.

According to further refinements of the invention as defined under the above aspect, the data base is a home location register in a GPRS mobile communication network.

According to a further aspect of the present invention, there is provided a managing node, comprising: a receiver adapted to receive a message from another managing node, a message composing unit adapted to compose a reply message including information about an identification of a switching device, and a transmitter adapted to transmit the reply message including the information about the identification of the switching device to the other managing node.

According to further refinements of the invention as defined under the above aspect, the managing node is an old SGSN in a GPRS mobile communication network and the other managing node is a new SGSN in a GPRS mobile communication network.

For the purpose of the present invention to be described herein below, it should be noted that

method steps likely to be implemented as software code portions and being run using a processor at one of the data base, managing node or switching device, are software code independent and can be specified using any known or future developed programming language as long as the functionality defined by the method steps is preserved;

generally, any method step is suitable to be implemented as software or by hardware without changing the idea of the present invention in terms of the functionality implemented;

method steps and/or devices likely to be implemented as hardware components at one of the entities (node, cluster router, managing node etc.) are hardware independent and can be implemented using any known or future developed hardware technology or any hybrids of these, such as MOS (Metal Oxide Semiconductor), CMOS (Complementary MOS), BiCMOS (Bipolar CMOS), ECL (Emitter Coupled Logic), TTL (Transistor Transistor Logic), etc., using for example ASIC (Application Specific Integrated Circuit) components or DSP (Digital Signal Processor) components, as an example;

devices can be implemented as individual devices, but this does not exclude that they are implemented in a distributed fashion throughout the system, as long as the functionality of the device/system is preserved;

respective elements, e.g. receiver, message composing unit etc. according to present embodiments can be implemented by any known means, either in hardware (DSP, microprocessor, microcontroller, ASIC, FPGA (Field Programmable Gate Array), AD- and DA-converters, power amplifiers, filters, antennas etc) and/or software, respectively, as long as it is adapted to perform the described functions of the respective parts.

### BRIEF DESCRIPTION OF THE DRAWINGS

The present invention is described herein below with reference to the accompanying drawings, wherein:

FIG. 1 is an overview of a mobile communication system to which the present invention is applicable;

FIG. 2 is a diagram showing messages exchanged during a location update procedure according to embodiments of the present invention;

FIG. 3 is a block diagram showing components of an HLR according to embodiments of the present invention; and

FIG. 4 is a block diagram showing components of an SGSN according to embodiments of the present invention.

### DETAILED DESCRIPTION OF EMBODIMENTS OF THE INVENTION

Embodiments of the present invention will be described herein below with reference to the accompanying drawings.

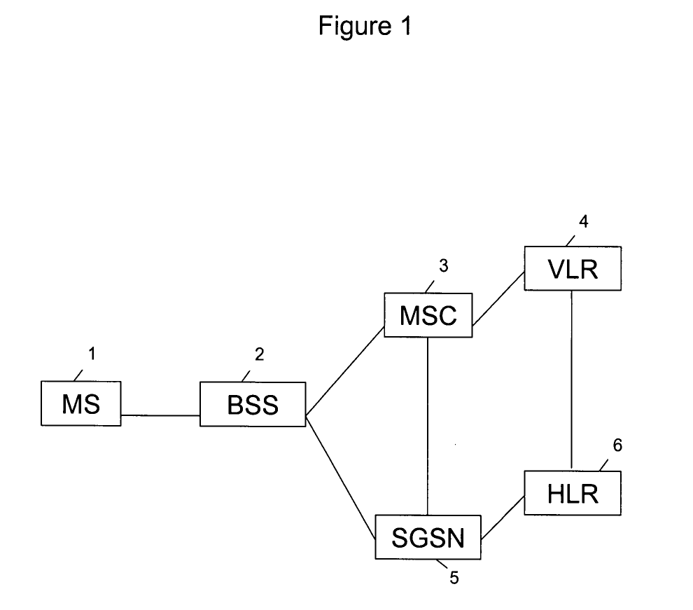

A mobile communication network, to which the present invention is applicable, may comprise the following elements, as shown in FIG. 1. Basically, a mobile communication network comprises a plurality of mobile stations MS 1 that are connected to base station subsystems BSS 2. The BSSs are connected to mobile switching centers MSC 3 that are in contact with respective VLRs 4, which have access to an HLR 6. Further, the network comprises SGSNs 5 which also has access to the HLR 6. It is to be noted that FIG. 1 only shows components of the mobile communication network that are relevant for understanding the principles of the present invention. However, it is apparent that a mobile communication network may also include other components that are not shown in FIG. 1.

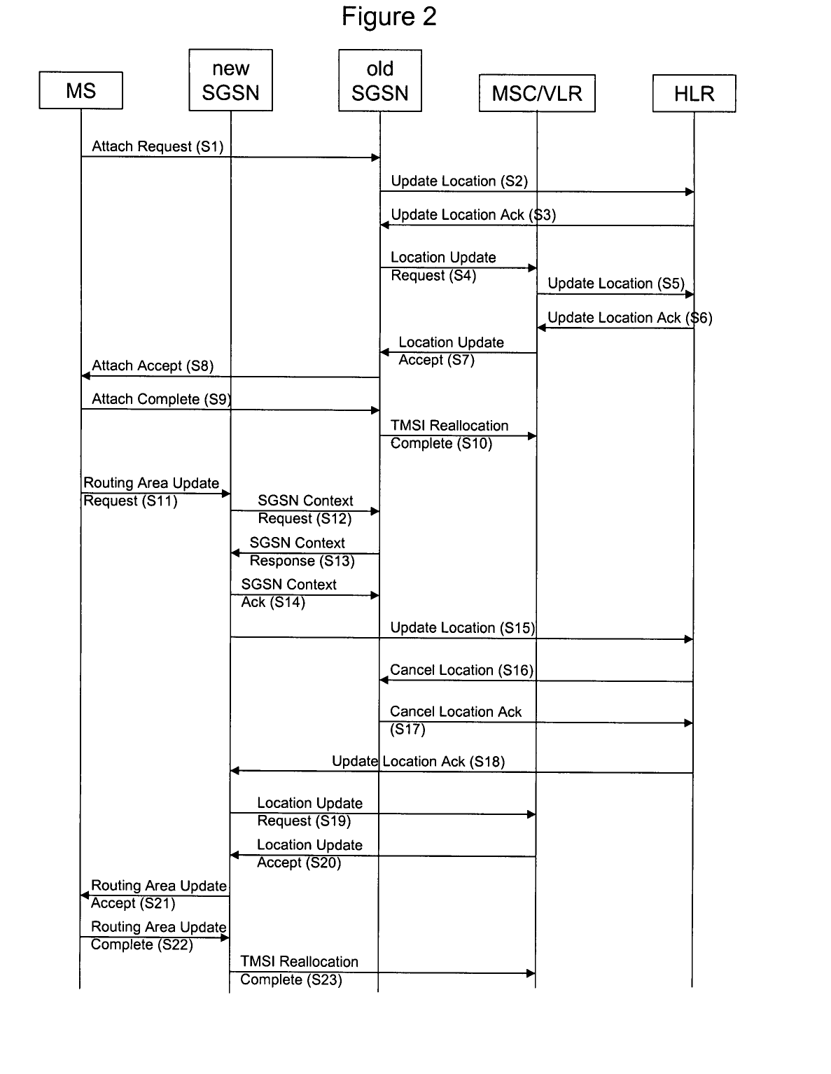

In the following, embodiments of the location update procedure according to the present invention will be described with reference to FIG. 2.

According to certain embodiments of the present invention, a mobile station MS sends an attach request via a BSS (not shown in FIG. 2) to an old SGSN (S1). Then, the old SGSN informs an HLR of the attach by sending an Update Location message to the HLR (S2). The HLR acknowledges the location update by sending an Update Location Acknowledgement message to the old SGSN (S3). Then, the old SGSN sends a Location Update Request message to the MSC/VLR (S4). The MSC/VLR informs an HLR of the attach by sending an Update Location message to the HLR (S5). The HLR acknowledges the location update by sending an Update Location Acknowledgement message to the MSC/VLR (S6). Then the MSC/VLR responds to old SGSN with a Location Update Accept message (S7).

After that, a logical link is established between the old SGSN and the MS, and the old SGSN sends a Attach Accept message to the MS (S8). Then, the MS confirms the reallocation of the TMSI by returning a Attach Complete message to the old SGSN (S9), and the old SGSN sends a TMSI Reallocation Complete message to the MSC/VLR (S10).

Further, a mobile station MS sends a routing area update request via a BSS (not shown in FIG. 2) to a new SGSN (S11). Then, the new SGSN sends an SGSN context request to the old SGSN and the old SGSN responds thereto with an SGSN context response (S12 and S13). After that the new SGSN sends an SGSN context acknowledge message to the old SGSN (S14).

Next, the new SGSN informs an HLR of the change of the SGSN by sending an Update Location message to the HLR (S15). Thereafter, the HLR sends a Cancel Location message to the old SGSN, which responds with a Cancel Location Acknowledge message (S16 and S17).

As a next step, the HLR acknowledges the location update by sending an Update Location Acknowledgement message to the new SGSN (S18). In this message, the HLR now directly includes the number of the MSC/VLR that has to be contacted by the new SGSN in order to request the location update.

Earlier the HLR has got the MSC/VLR number from the MSC/VLR when MS has performed a location update to the service area of this MSC/VLR for the first time. The HLR has stored this received MSC/VLR number to the database (HLR's database) after the completion of the location update. Therefore, the SGSN does not have to derive the number of the MSC/VLR from the IMSI using the RAI and a hash value from the IMSI.

Thus, the new SGSN reliably knows the number of the MSC/VLR and sends a Location Update Request message to the MSC/VLR (S19). The MSC/VLR then allocates a new TMSI (Temporary Mobile Subscriber Identity) and responds with a Location Update Accept message (S20).

After that, a logical link is established between the new SGSN and the MS, and the new SGSN sends a Routing Area Update Accept message to the MS (S21). Then, the MS confirms the reallocation of the TMSI by returning a Routing Area Update Complete message to the new SGSN (S22), and the new SGSN sends a TMSI Reallocation Complete message to the MSC/VLR (S23).

Hence, according to the present invention, since the number of the MSC/VLR has been directly transmitted by the HLR, it is assured that the Location Update Request is sent to the correct MSC/VLR. Therefore, the location update is performed faster when multipoint functionality is used.

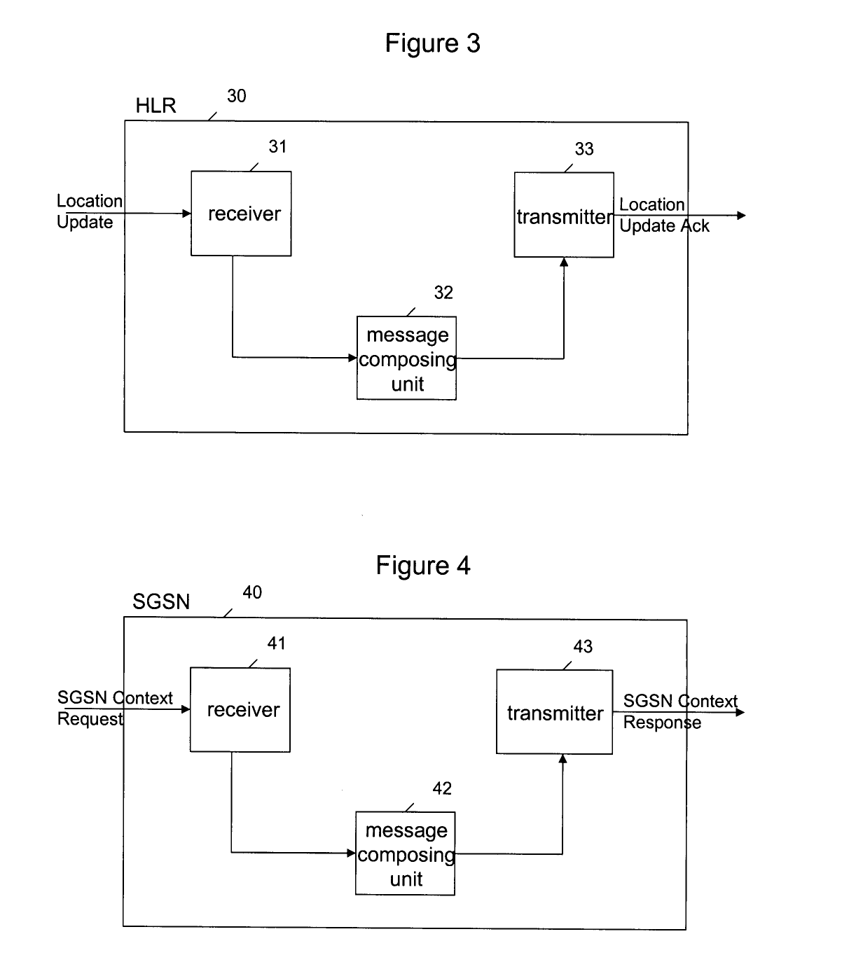

FIG. 3 is a block diagram showing components of an HLR according to embodiments the present invention.

An HLR 30 according to an embodiment of the present invention comprises a receiver 31, e.g. for receiving a Location Update message from a new SGSN. The HLR further comprises a message composing unit 32 that composes messages to be sent by the HLR, like for example the Cancel Location message or the Update Location Acknowledgement message. When composing the Update Location Acknowledge message, the composing unit 32 inserts the number of the MSC/VLR into this message to be sent to the new SGSN. Then a transmitter 33 of the HLR 30 transmits the Update Location Acknowledge message containing the number of the MSC/VLR to the new SGSN.

In the foregoing description of the HLR, only the units that are relevant for understanding the principles of the invention have been described using functional blocks. Of course it is obvious that the HLR may comprise further units that are necessary for their operation. However, a description of these units is omitted in this specification. The arrangement of the functional blocks of the HLR is not construed to limit the invention, and the functions may be performed by one block or further split into sub-blocks.

In another embodiment of the present invention, the update procedure is performed in a similar manner as described above. However, according to the present embodiment, the number of the MSC/VLR is directly sent from the old SGSN to the new SGSN in the SGSN context response (S13). In a similar way as described above, the old SGSN has got the MSC/VLR number from the MSC/VLR when the MS has performed a location update to the service area of this MSC/VLR for the first time. The SGSN has stored this received MSC/VLR number to the database (SGSN's database) after the completion of the location update. Thus, in this embodiment, the number of the MSC/VLR is not contained in the location update acknowledge message from the HLR, but in the SGSN context response from the old SGSN. The remaining steps are performed in a similar manner as described above.

In general, when the SGSN changes but the MSC/VLR does not change, the new SGSN selects the same MSC/VLR to establish a Gs association because the new SGSN uses the same selection mechanism with the same parameters as configured in the old SGSN.

However, according to the prior art method, if the old SGSN and the new SGSN use different parameters (e.g. the SGSNs are from different vendors or the SGSNs are configured in a different way), the selection mechanism in new SGSN would not give the same MSC/VLR number than it did in the old SGSN. This would cause unnecessary change of the MSC/VLR.

In contrast thereto, according to embodiments of the present invention, when the new SGSN gets the MSC/VLR number from the HLR in the Update Location Ack message (S18), or from the old SGSN in the SGSN context response (S13), the new SGSN will send the Location Update Request message (S19) to the correct MSC/VLR, and therefore, the MSC/VLR will not change unnecessarily.

FIG. 4 is a block diagram showing components of an SGSN according to embodiments of the present invention.

The SGSN 40 in the present embodiment constitutes an old SGSN, which manages the mobile station MS before the location update to a new SGSN.

The old SGSN 40 according to the present embodiment comprises a receiver 41, e.g. for receiving an SGSN context request message from a new SGSN. The old SGSN further comprises a message composing unit 42 that composes messages to be sent by the old SGSN, like for example the SGSN Context Response message. When composing the SGSN Context Response message, the composing unit 42 inserts the number of a MSC/VLR that has to be contacted by the new SGSN into this message to be sent to the new SGSN. Then a transmitter 43 of the old SGSN 40 transmits the SGSN context response message containing the number of the MSC/VLR to the new SGSN.

In the foregoing description of the SGSN, only the units that are relevant for understanding the principles of the invention have been described using functional blocks. Of course it is obvious that the SGSN may comprise further units that are necessary for their operation. However, a description of these units is omitted in this specification. The arrangement of the functional blocks of the SGSN is not construed to limit the invention, and the functions may be performed by one block or further split into sub-blocks.

Further, it is to be noted that all processing steps that have been described in the foregoing can also be implemented using computer-readable signals that may be stored on a computer-readable medium and carry instructions to be executed by one of the data base, managing node or switching device.

In view of the foregoing description it will be evident to a person skilled in the art that various modifications may be made within the scope of the invention.

1. A method comprising:
receiving, at a data base, a location update request message from a managing node,
composing, at the data base, a location update acknowledge message including information about an identification of a switching device, and
transmitting, by the data base, the location update acknowledge message including the information about the identification of the switching device to the managing node.

2. A method according to claim 1,
the managing node being a serving GPRS support node, the data base being a home location register and the switching device being a mobile switching center in a GPRS mobile communication network.

3. A method according to claim 1,
the identification of the switching device being the number of a MSC/VLR.

4. A method comprising:
receiving, at a managing node, a message from another managing node,
composing, at the managing node, a reply message including information about an identification of a switching device,
transmitting, by the managing node, the reply message including the information about the identification of the switching device to the other managing node.

5. A method according to claim 4,
the managing node being an old serving GPRS support node, the other managing node being a new serving GPRS support node, the data base being a home location register and the switching device being a mobile switching center in a GPRS mobile communication network.

6. A method according to claim 4,
the identification of the switching device being the number of a MSC/VLR.

7. A data base, comprising:
a receiver adapted to receive a location update request message from a managing node,
a message composing unit adapted to compose a location update acknowledge message including information about an identification of a switching device, and
a transmitter adapted to transmit the location update acknowledge message including the information about the identification of the switching device to the managing node.

8. The data base according to claim 7,
the data base being a home location register in a GPRS mobile communication network.

9. A managing node, comprising:
a receiver adapted to receive a message from another managing node,
a message composing unit adapted to compose a reply message including information about an identification of a switching device, and
a transmitter adapted to transmit the reply message including the information about the identification of the switching device to the other managing node.

10. The managing node according to claim 9,
the managing node being an old SGSN in a GPRS mobile communication network and the other managing node being a new SGSN in a GPRS mobile communication network.

11. A data base, comprising:
a receiver means for receiving a location update request message from a managing node,
a message composing means for composing a location update acknowledge message including information about an identification of a switching device, and
a transmitter means for transmitting the location update acknowledge message including the information about the identification of the switching device to the managing node.

12. A managing node, comprising:
a receiver means for receiving a message from another managing node,
a message composing means for composing a reply message including information about an identification of a switching device, and
a transmitter means for transmitting the reply message including the information about the identification of the switching device to the other managing node.
